(19) United States
(12) Patent Application Publication
(10) Pub. No.: US 2006/0179714 A1
(43) Pub. Date: Aug. 17, 2006

(54) Method of covering a pot with a floral sleeve having a side-sealed bottom gusset

(76) Inventors: Donald E. Weder, Highland, IL (US); Joseph G. Straeter, Bradenton, FL (US); Michael R. Klemme, Maryville, IL (US)

Correspondence Address: DUNLAP, CODDING & ROGERS P.C., PO BOX 16370, OKLAHOMA CITY, OK, 73113, US

(21) Appl. No.: 11/398,422

(22) Filed: Apr. 5, 2006

Related U.S. Application Data
(63) Continuation of application No. 10/635,043, filed on Aug. 5, 2003, now abandoned.
Application No. 10/635,043 is a continuation-in-part of application No. 09/972,499, filed on Oct. 5, 2001, now abandoned.
Application No. 10/635,043 is a continuation-in-part of application No. 10/423,497, filed on Apr. 24, 2003.
Application No. 10/423,497 is a continuation-in-part of application No. 09/954,665, filed on Sep. 18, 2001, now abandoned.
Application No. 09/954,665 is a continuation-in-part of application No. 09/612,122, filed on Jul. 7, 2000, now Pat. No. 6,385,904.
Application No. 09/612,122 is a continuation of application No. 09/466,705, filed on Dec. 17, 1999, now Pat. No. 6,105,311.
Application No. 09/466,705 is a continuation of application No. 09/062,329, filed on Apr. 17, 1998, now Pat. No. 6,061,959.
Application No. 09/062,329 is a continuation of application No. 08/749,626, filed on Nov. 18, 1996, now Pat. No. 5,829,194.
Application No. 08/749,626 is a continuation-in-part of application No. 08/458,327, filed on Jun. 2, 1995, now Pat. No. 5,575,133.
Application No. 08/458,327 is a continuation of application No. 08/386,859, filed on Feb. 10, 1995, now Pat. No. 5,493,809.
Application No. 08/386,859 is a continuation-in-part of application No. 08/237,078, filed on May 3, 1994, now Pat. No. 5,625,979.
Application No. 08/237,078 is a continuation-in-part of application No. 08/220,852, filed on Mar. 31, 1994, now Pat. No. 5,572,851.

(51) Int. Cl. A01G 9/02

(52) U.S. Cl. 47/72

(57) ABSTRACT

A floral sleeve and method of using the floral sleeve to cover a pot. The floral sleeve has an inwardly folded bottom gusset for forming a bottom in the sleeve which is concealed by the lower sidewall of the sleeve when the sleeve is opened and a pot is disposed therein. The sleeve may have a detachable upper portion.

### CROSS REFERENCE TO RELATED APPLICATIONS

The present application is a continuation of U.S. Ser. No. 10/635,043, filed Aug. 5, 2003, now abandoned; which is a continuation-in-part of U.S. Ser. No. 09/972,499, filed Oct. 5, 2001, now abandoned. Said U.S. Ser. No. 10/635,043 is also a continuation-in-part of U.S. Ser. No. 10/423,497, filed Apr. 24, 2003; which is a continuation-in-part of U.S. Ser. No. 09/954,665, filed Sep. 18, 2001, now abandoned; which is a continuation-in-part of U.S. Ser. No. 09/612,122, filed Jul. 7, 2000, now U.S. Pat. No. 6,385,904, issued May 14, 2002; which is a continuation of U.S. Ser. No. 09/466,705, filed on Dec. 17, 1999, now U.S. Pat. No. 6,105,311, issued Aug. 22, 2000; which is a continuation of U.S. Ser. No. 09/062,329, filed Apr. 17, 1998, now U.S. Pat. No. 6,061,959, issued May 16, 2000; which is a continuation of U.S. Ser. No. 08/749,626, filed Nov. 18, 1996, now U.S. Pat. No. 5,829,194, issued Nov. 3, 1998; which is a continuation-in-part of U.S. Ser. No. 08/458,327, filed Jun. 2, 1995, now U.S. Pat. No. 5,575,133, issued Nov. 19, 1996; which is a continuation of U.S. Ser. No. 08/386,859, filed Feb. 10, 1995, now U.S. Pat. No. 5,493,809, issued Feb. 27, 1996; which is a continuation-in-part of U.S. Ser. No. 08/237,078, filed May 3, 1994, now U.S. Pat. No. 5,625,979, issued May 6, 1997; which is a continuation-in-part of U.S. Ser. No. 08/220,852, filed Mar. 31, 1994, now U.S. Pat. No. 5,572,851, issued Nov. 12, 1996. All of the patent applications and patents listed herein above are hereby expressly incorporated herein by reference in their entireties.

### BACKGROUND

This invention generally relates to sleeves, and, more particularly, to floral sleeves used to contain floral groupings and/or media, or used to wrap flower pots containing floral groupings and/or media containing floral grouping, and methods of using same.

U.S. Pat. Nos. 5,595,022; 5,615,535; 5,740,657; 5,816,023; 5,687,845; 5,810,169; 5,944,187 and 6,152,301, contain subject matter which may be relevant to the present application. The disclosures of each of the above-mentioned patents are hereby expressly incorporated herein by reference.

### BRIEF DESCRIPTION OF THE DRAWINGS

FIG. 1 is an elevational view of a floral sleeve constructed in accordance with the present invention.

FIG. 2 is a cross-sectional view of the floral sleeve of FIG. 1 taken along line 2-2 thereof.

FIG. 3 is a perspective view of the floral sleeve of FIG. 1.

FIG. 4 is a perspective view of the floral sleeve of FIG. 1 in an opened condition and having a pot and floral grouping disposed therein.

FIG. 5 is a bottom plan view of the opened floral sleeve of FIG. 4.

FIG. 6 is an elevational view of an alternate embodiment of the floral sleeve of the present invention.

FIG. 7 is an elevational view of an alternate embodiment of the floral sleeve of the present invention.

FIG. 8 is an elevational view of an alternate embodiment of the floral sleeve of the present invention.

FIG. 9 is an elevational view of an alternate embodiment of the floral sleeve of the present invention.

FIG. 10 is a perspective view of the floral sleeve of FIG. 9 having a pot and floral grouping disposed therein.

FIG. 11 is an elevational view of an alternate embodiment of the floral sleeve of the present invention.

FIG. 12 is an elevational view of an alternate embodiment of the floral sleeve of the present invention.

FIG. 13 is an elevational view of an alternate embodiment of the floral sleeve of the present invention.

FIG. 14 is an elevational view of an alternate embodiment of the floral sleeve of the present invention.

### DETAILED DESCRIPTION OF THE INVENTION

The present invention contemplates in a preferred version a preformed flexible floral sleeve having a tubular shape for covering a flower pot having an upper end, a lower end, and an outer peripheral surface. The preformed flexible floral sleeve comprises a body which may have a skirt portion and which may have a straight or non-linear upper edge. The preformed flexible floral sleeve may further comprise a detachable upper portion which may be sized to surround and encompass a floral grouping. The upper portion when present may be detachable via a detaching element, such as but not by way of limitation, perforations, tear strips, weakened areas, or zippers. The upper portion may have one or more apertures for serving as a handle or for enabling the preformed flexible floral sleeve to be supported from a support device.

The preformed flexible floral sleeve (also referred to herein as a floral sleeve, a sleeve or a sleeve cover) may form part of a plant package when used in conjunction with a flower pot disposed within an interior space of the body of the floral sleeve, the flower pot preferably having a floral grouping disposed therein, and wherein the flower pot is substantially surrounded and encompassed by the body and the floral grouping is at least partially surrounded and encompassed and may be entirely enclosed by the upper portion when it forms a part of the floral sleeve.

Also, the body may comprise an adhesive or cohesive bonding material disposed on an inner surface thereof for bondingly connecting the body to a flower pot disposed therein. Alternately, a bonding material may be disposed on an outer surface of the body for securing a crimped portion having a plurality of crimped folds formed in the body.

These embodiments and others of the present invention are now described in more detail below. It will be appreciated that the examples provided herein are not intended to limit the scope and extent of the claimed invention but are only intended to exemplify various of the embodiments of the invention contemplated herein.

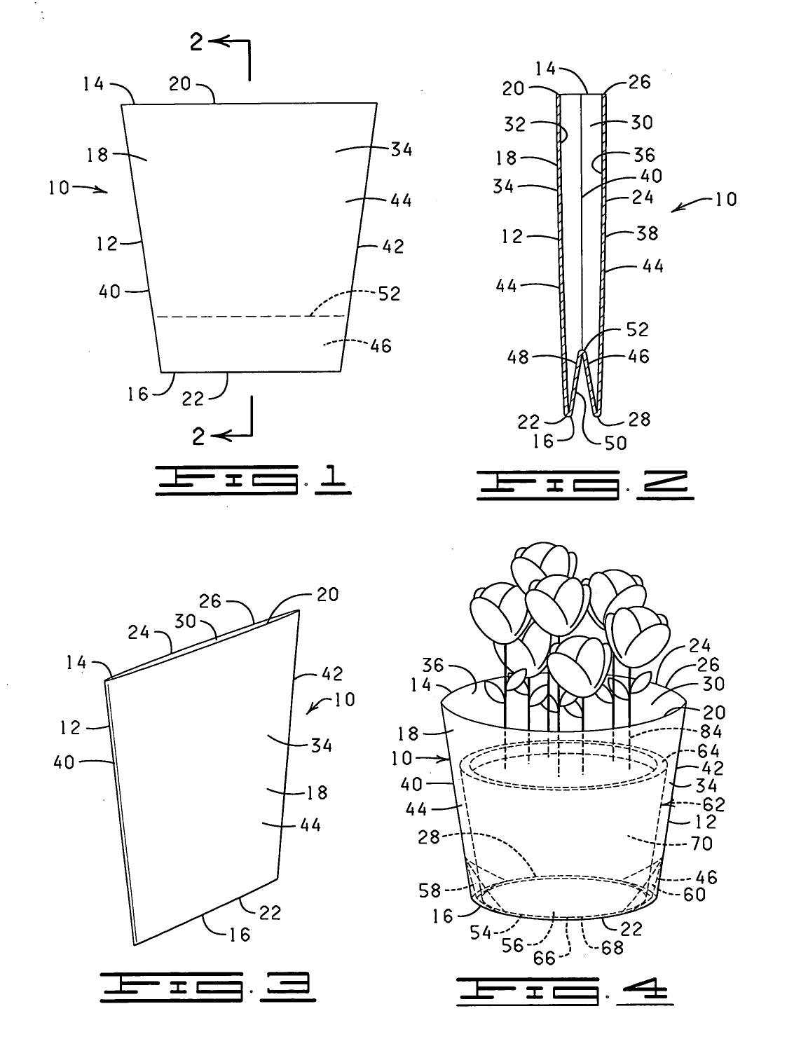

### EMBODIMENTS OF FIGS. 1-14

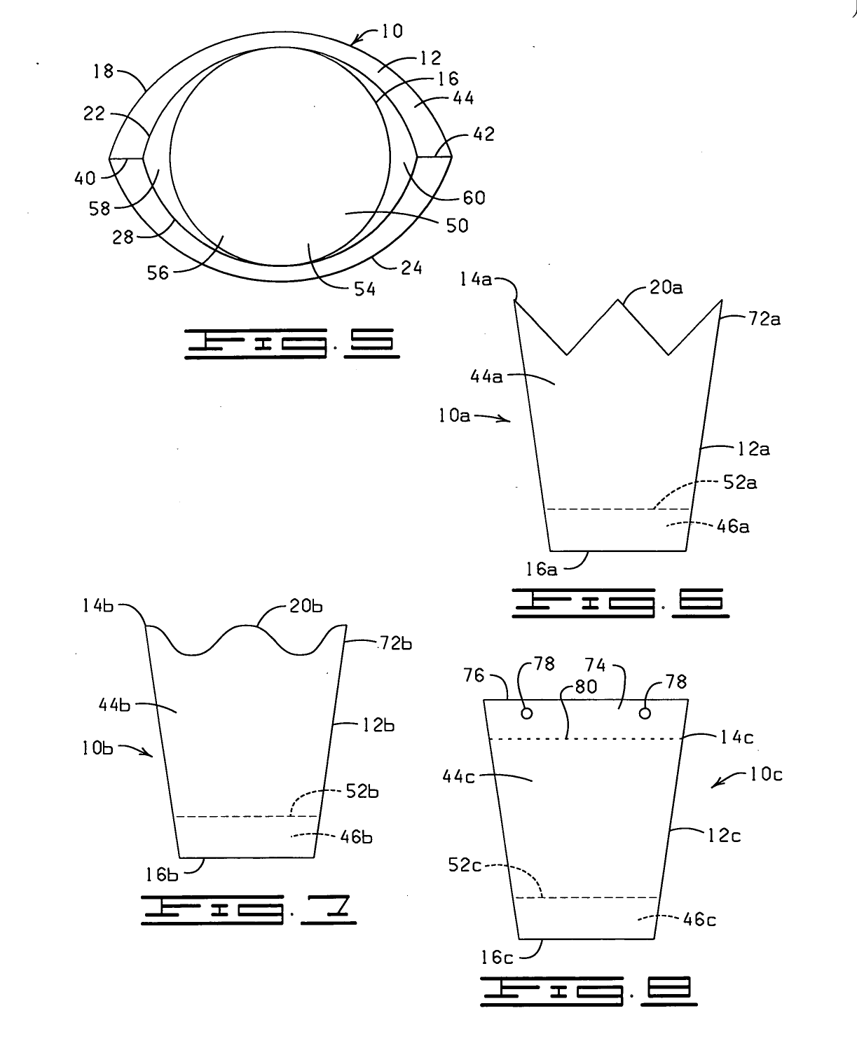

Referring now to the drawing, shown in FIGS. 1-5 and designated therein by the general reference numeral 10 is a floral sleeve, also referred to herein simply as a sleeve. The floral sleeve 10 is initially in a substantially flattened state (FIGS. 1-3) and is openable to an opened condition (FIGS. 4-5) for containing and covering a flower pot.

The floral sleeve 10 has a body 12 having an upper end 14, a lower end 16, a first panel 18 having a first upper edge 20 and a first lower edge 22 and a second panel 24 having a second upper edge 26 and a second lower edge 28 which is generally parallel and adjacent to the first lower edge 22.

The body 12 has an interior space 30. The first panel 18 has an inner surface 32 and an outer surface 34. The second panel 24 has an inner surface 36 and an outer surface 38.

In the flattened condition, the first panel 18 and second panel 24 are positioned flatwise upon each other and are connected along a sealed left side edge 40 and a sealed right side edge 42 both of which extend from the upper end 14 to the lower end 16. The first panel 18 and second panel 24 together comprise a sidewall 44 of the body 12. The body 12 further comprises a gusset 46 extending inwardly into the interior space 30 from the first lower edge 22 and the second lower edge 28. The gusset 46 has an inner surface 48 exposed to the interior space 30 and an outer surface 50 exposed outwardly. The gusset 46 has an inner fold 52 which extends from the left side edge 40 to the right side edge 42. The body 12 preferably has a tapered shape in the flattened condition, wherein the body 12 is wider at the upper end 14 and more narrow at the lower end 16, such that in the opened condition the floral sleeve 10 preferably has a frusto-conical shape (FIG. 4). As noted, the floral sleeve 10 preferably has a frusto-conical shape when opened, but may be cylindrical or may even have a rectangular shape when opened.

When the floral sleeve 10 is converted to an opened condition, the gusset 46 is unfolded to form a bottom 54 in the body 12. When a pot 62 is disposed within the interior space 30 and a bottom 68 of a lower end 66 of the pot 62 is disposed upon the bottom 54 of the body 12, the bottom 54 has three surface portions, including (1) a lower bottom surface 56 covering the bottom 68 of the pot 62, (2) a left side bottom surface 58 which extends upwardly from the lower bottom surface 56 and is disposed between the sidewall 44 of the body 12 and an outer peripheral surface 70 of the pot, and (3) a right side bottom surface 60 which extends upwardly from the lower bottom surface 56 and is disposed between the sidewall 44 of the body 12 and the outer peripheral surface 70 of the pot. In the opened condition of the floral sleeve 10, the bottom 54 of the body 12 is substantially completely concealed by a lower portion of the sidewall 44 of the body 12.

Referring now to FIG. 6, another floral sleeve embodied in the present invention is designated therein by reference numeral 10a. Floral sleeve 10a has a body 12a, an upper end 14a, a lower end 16a, an upper edge 20a, a sidewall 44a, a gusset 46a, and an inner gusset fold 52a. The floral sleeve 10a is essentially the same as floral sleeve 10 except the upper edge 20a has an angular pattern forming a skirt portion 72 in the body 12a. The skirt portion 72 is generally sized to extend a distance above an upper end 64 of the pot 62 (FIG. 4) when the pot 62 is disposed within the floral sleeve 10a when in the opened condition.

Referring now to FIG. 7 another floral sleeve embodied in the present invention is designated therein by reference numeral 10b. Floral sleeve 10b has a body 12b, an upper end 14b, a lower end 16b, an upper edge 20b, a sidewall 44b, a gusset 46b, and an inner gusset fold 52b. The floral sleeve 10b is essentially the same as floral sleeve 10 except the upper edge 20b has a curved pattern forming a skirt portion 72b in the body 12b. The skirt portion 72b is generally sized to extend a distance above the upper end 64 of the pot 62 when the pot 62 is disposed within the floral sleeve 10b when in the opened condition.

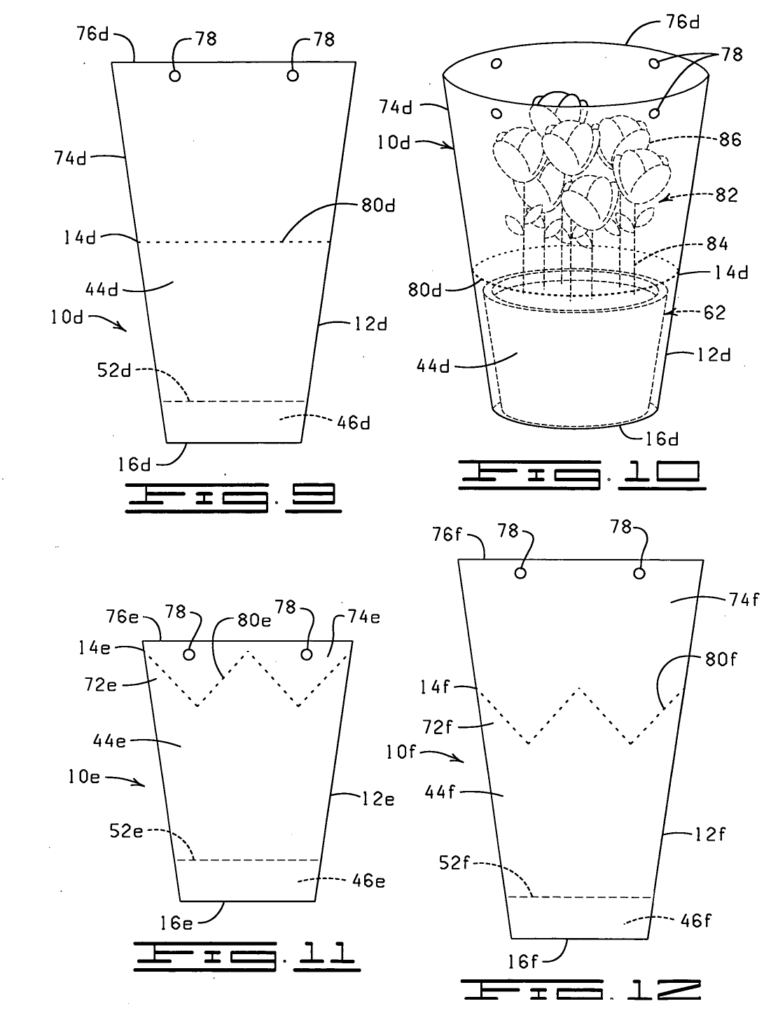

Referring now to FIG. 8, another floral sleeve embodied in the present invention is designated therein by reference numeral 10c. Floral sleeve 10c has a body 12c, an upper end 14c, a lower end 16c, a sidewall 44c, a gusset 46c, and an inner gusset fold 52c. The floral sleeve 10c is essentially similar to floral sleeve 10 except the floral sleeve 10c further comprises an upper portion 74 having an upper edge 76, and apertures 78 and which is detachable via a detaching element 80. The apertures 78 are optional and serve to adapt the upper portion 74 to support the entire floral sleeve 10c from a support assembly such as a wicket, or staple, for example. In an alternative embodiment, a plurality of floral sleeves 10c may be provided in a pad, with the upper portions 74 of adjacent floral sleeves 10c connected together by an adhesive or cohesive bonding material in a manner well known in the art. Preferably, the body 12c of the floral sleeve 10c is detached from the upper portion 74 before the body 10c is placed about the pot 62.

Referring now to FIGS. 9 and 10, another floral sleeve embodied in the present invention is designated therein by reference numeral 10d. Floral sleeve 10d has a body 12d, an upper end 14d, a lower end 16d, a sidewall 44d, a gusset 46d, and an inner gusset fold 52d. The floral sleeve 10d is essentially similar to floral sleeve 10 except the floral sleeve 10d further comprises upper portion 74d having an upper edge 76, apertures 78 and which is detachable via a detaching element 80d. The apertures 78 are optional and serve to adapt the upper portion 74d to support the entire floral sleeve 10d from a support assembly such as a wicket, or staple, for example. In an alternative embodiment, a plurality of floral sleeves 10d may be provided in a pad, with the upper portions 74d of adjacent floral sleeves 10d connected together by an adhesive or cohesive bonding material in a manner well known in the art.

The upper portion 74d is generally sized to surround and enclose a floral grouping 82 having a lower portion 84 and an upper portion 86 comprising blooms or foliage, which is disposed within the pot 62 when the pot 62 and floral grouping 82 therein is disposed within the opened floral sleeve 10d. The upper portion 74d is generally detached from the body 12d via the detaching element 80d at some time after the floral sleeve 10d has been disposed about the pot 62 and floral grouping 82, for example after the pot 62 and floral grouping 82 therein have been shipped to a vendor, but may be detached at any time, either before or after the pot 62 and floral grouping 82 are placed within the floral sleeve 10d.

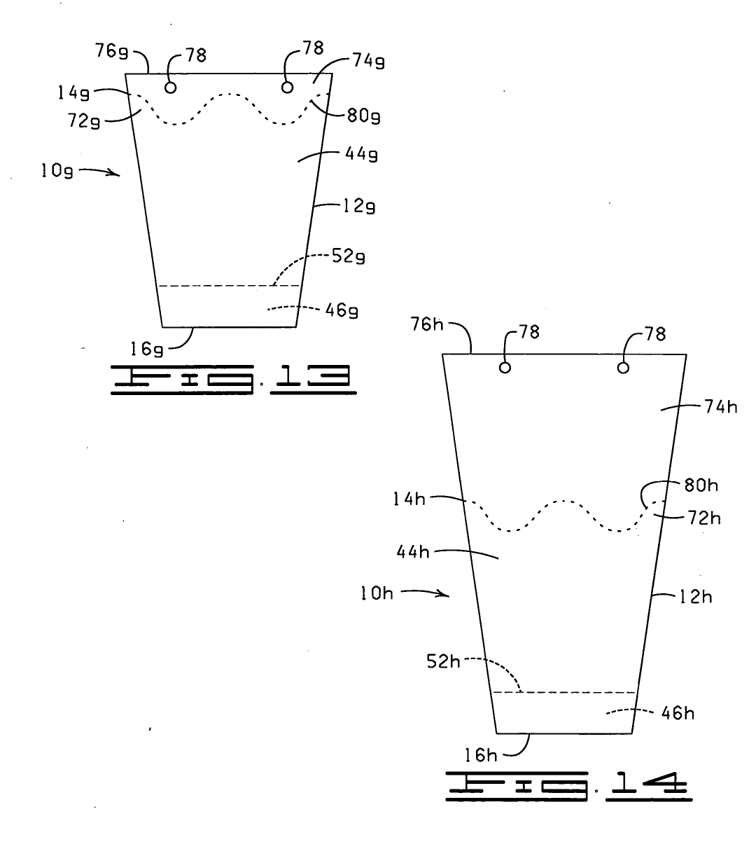

Referring now to FIG. 11, another floral sleeve embodied in the present invention is designated therein by reference numeral 10e. Floral sleeve 10e has a body 12e, an upper end 14e, a lower end 16e, a sidewall 44e, a gusset 46e, and an inner gusset fold 52e. The floral sleeve 10e is essentially similar to floral sleeve 10c in that the floral sleeve 10e comprises upper portion 74e having an upper edge 76, apertures 78 and which is detachable via a detaching element 80e. The apertures 78 are optional and serve to adapt the upper portion 74e to support the entire floral sleeve 10e from a support assembly such as a wicket, or staple, for example. In an alternative embodiment, a plurality of floral sleeves 10e may be provided in a pad, with the upper portions 74e of adjacent floral sleeves 10e connected together by an adhesive or cohesive bonding material or other attaching device in a manner well known in the art. Preferably, the body 12e of the floral sleeve 10e is detached from the upper portion 74e before the body 10e is placed about the pot 62.

The detaching element 80e differs from detaching element 80 of floral sleeve 10c in that detaching element 80e has an angular pattern rather than a substantially horizontal problem, such that when the upper portion 74e is detached from the body 12e, a skirt portion 72e is left on the body 12e. The skirt portion 72e preferably is sized to extend above the upper end 64 of the pot 62 when disposed within the floral sleeve 10e.

Referring now to FIG. 12, another floral sleeve embodied in the present invention is designated therein by reference numeral 10f. Floral sleeve 10f has a body 12f, an upper end 14f, a lower end 16f, a sidewall 44f, a gusset 46f, and an inner gusset fold 52f. The floral sleeve 10f is essentially similar to floral sleeve 10d in that the floral sleeve 10f comprises upper portion 74f having an upper edge 76f, apertures 78 and which is detachable via a detaching element 80f. The apertures 78 are optional and serve to adapt the upper portion 74f to support the entire floral sleeve 10f from a support assembly such as a wicket, or staple, for example. In an alternative embodiment, a plurality of floral sleeves 10f may be provided in a pad, with the upper portions 74f of adjacent floral sleeves 10f connected together by an adhesive or cohesive bonding material or other attaching device in a manner well known in the art.

The upper portion 74f is generally sized to surround and enclose the floral grouping 82 having the lower portion 84 and the upper portion 86 comprising blooms or foliage, which is disposed within the pot 62 when the pot 62 and floral grouping 82 therein is disposed within the opened floral sleeve 10f. The upper portion 74f is generally detached from the body 12f via the detaching element 80f at some time after the floral sleeve 10f has been disposed about the pot 62 and the floral grouping 82, for example after the pot 62 and floral grouping 82 therein have been shipped to a vendor, but may be detached at any time, either before or after the pot 62 and floral grouping 82 are placed within the floral sleeve 10d.

The detaching element 80f differs from detaching element 80 of floral sleeve 10d in that detaching element 80f has an angular pattern rather than a substantially horizontal problem, such that when the upper portion 74f is detached from the body 12f, a skirt portion 72f is left on the body 12f. The skirt portion 72f preferably is sized to extend above the upper end 64 of the pot 62 when disposed within the floral sleeve 10f.

Referring now to. FIG. 13, another floral sleeve embodied in the present invention is designated therein by reference numeral 10g. Floral sleeve 10g has a body 12g, an upper end 14g, a lower end 16g, a sidewall 44g, a gusset 46g, and an inner gusset fold 52g. The floral sleeve log is essentially similar to floral sleeve 10c in that the floral sleeve 10g comprises an upper portion 74g having an upper edge 76, apertures 78 and which is detachable via a detaching element 80g. The apertures 78 are optional and serve to adapt the upper portion 74g to support the entire floral sleeve 10g from a support assembly such as a wicket, or staple, for example. In an alternative embodiment, a plurality of floral sleeves 10g may be provided in a pad, with the upper portions 74g of adjacent floral sleeves 10g connected together by an adhesive or cohesive bonding material or other attaching device in a manner well known in the art. Preferably, the body 12g of the floral sleeve 10g is detached from the upper portion 74g before the body log is placed about the pot 62.

The detaching element 80g differs from detaching element 80 of floral sleeve 10c in that detaching element 80g has an curved pattern rather than a substantially horizontal problem, such that when the upper portion 74g is detached from the body 12g, a skirt portion 72g is left on the body 12g. The skirt portion 72g preferably is sized to extend above the upper end 64 of the pot 62 when disposed within the floral sleeve 10g.

Referring now to FIG. 14, another floral sleeve embodied in the present invention is designated therein by reference numeral 10h. Floral sleeve 10h has a body 12h, an upper end 14h, a lower end 16h, a sidewall 44h, a gusset 46h, and an inner gusset fold 52h. The floral sleeve 10h is essentially similar to floral sleeve 10d in that the floral sleeve 10h comprises an upper portion 74h having an upper edge 76, and apertures 78 and which is detachable via a detaching element 80h. The apertures 78 are optional and serve to adapt the upper portion 74h to support the entire floral sleeve 10h from a support assembly such as a wicket, or staple, for example. In an alternative embodiment, a plurality of floral sleeves 10h may be provided in a pad, with upper portions 74h of adjacent floral sleeves 10h connected together by an adhesive or cohesive bonding material or other attaching device in a manner well known in the art.

The upper portion 74h is sized to surround and enclose a floral grouping 82 having a lower portion 84 and an upper portion 86 comprising blooms or foliage, disposed within the pot 62 when the pot 62 and floral grouping 82 therein is disposed within the opened floral sleeve 10h. The upper portion 74h is generally detached from the body 12h via the detaching element 80h at some time after the floral sleeve 10h has been disposed about the pot 62 and floral grouping 82, for example after the pot 62 and floral grouping 82 therein have been shipped to a vendor, but may be detached at any time, either before or after the pot 62 and floral grouping 82 are placed within the floral sleeve 10d.

The detaching element 80h differs from detaching element 80 of floral sleeve 10d in that detaching element 80h has an curved pattern rather than a substantially horizontal problem, such that when the upper portion 74h is detached from the body 12h, a skirt portion 72h is left on the body 12h. The skirt portion 72h preferably is sized to extend above the upper end 64 of the pot 62 when disposed within the floral sleeve 10h.

The upper edges 20a and 20b of sleeves 10a and 10b, respectively, and the detaching element 80e-80h of sleeves 10e-10h, respectively, are shown as having angular or curved non-linear patterns. The angular and curved patterns are but two non-linear patterns which may be employed in the construction of the floral sleeves contemplated herein. Other configurations will be readily apparent to those of ordinary skill in the art, for example, those shown in FIGS. 2A-2F of U.S. Pat. No. 5,829,225, the specification of which is hereby expressly incorporated herein by reference in its entirety.

Any of the flexible floral sleeves contemplated herein may also be equipped with drainage elements (e.g., one or more holes) in the bodies 10-10h thereof or ventilation holes (not shown) in the bodies 10-10h or upper portions 74d, 74f or 74h or can be made from permeable or impermeable materials.

The material from which the flexible floral sleeves 10-10h are constructed preferably has a thickness in a range from about 0.1 mil to about 30 mil. Often, the thicknesses of the floral sleeves 10-10h are in a range from about 0.5 mil to about 10 mil or preferably, in a range from about 1.0 mil to about 5 mil. Preferably, the floral sleeves 10-10h are constructed from a material which is flexible, semi-rigid, rigid, or any combination thereof. The floral sleeves 10-10h may be constructed of a single layer of material or a plurality of layers of the same or different types of materials. Any thickness of the material may be utilized as long as the material functions in accordance with the present invention as described herein. The layers of material comprising the flexible floral sleeves may be connected together or laminated or may be separate layers. Such materials used to construct the floral sleeves are described in U.S. Pat. No. 5,111,637, which is hereby incorporated herein by reference. Any thickness of material may be utilized in accordance with the present invention as long as the floral sleeves 10-10h may be formed as described herein, and as long as the floral sleeves 10-10h may contain at least a portion of a flower pot, potted plant, growing medium or floral grouping, as described herein. Additionally, an insulating material such as bubble film, preferable as one of two or more layers, can be utilized in order to provide additional protection for the item, such as the floral grouping, contained therein.

The floral sleeves 10-10h are constructed from any suitable material that is capable of being formed into a floral sleeve as contemplated herein and wrapped about a flower pot and a floral grouping disposed therein. Preferably, the material comprises treated or untreated paper, metal foil, polymeric film, non-polymeric film woven, or nonwoven fabric, or synthetic or natural fabric, cardboard, fiber, cloth, burlap, or laminations or combinations thereof.

The term “polymeric film” when used herein means a film made of a synthetic polymer such as a polypropylene or a naturally occurring polymer such as cellophane. A polymeric film is relatively strong and not as subject to tearing (substantially non-tearable), as might be the case with paper or foil.

In one embodiment, the floral sleeves 10-10h may be constructed from sheets comprising two polypropylene films. The material comprising the flexible floral sleeves 10-10h may be connected together or laminated or may be separate layers. In an alternative embodiment, the flexible floral sleeves 10-10h may be constructed from only one sheet of the polypropylene film.

The materials comprising the floral sleeves 10-10h may vary in color and as described herein consists of designs or decorative patterns which are printed, etched, and/or embossed thereon using inks or other printing materials. An example of an ink which may be applied to the surface of the material is described in U.S. Pat. No. 5,147,706, which is hereby expressly incorporated herein by reference.

In addition, the material may have various colorings, coatings, flocking and/or metallic finishes, or other decorative surface ornamentation applied separately or simultaneously or may be characterized totally or partially by pearlescent, translucent, transparent, iridescent, neon, or the like, qualities. The material may further comprise, or have applied thereto, one or more scents. Each of the above-named characteristics may occur alone or in combination and may be applied to the upper and/or lower surface of the material comprising the floral sleeves 10-10h. Moreover, portions of the material used in constructing the floral sleeves 10-10h may vary in the combination of such characteristics. The material utilized for the floral sleeves 10-10h may be opaque, translucent, transparent, or partially clear or tinted transparent.

The term “floral grouping” as used herein means cut fresh flowers, artificial flowers, a single flower or other fresh and/or artificial plants or other floral materials and may include other secondary plants and/or ornamentation or artificial or natural materials which add to the aesthetics of the overall floral grouping. The floral grouping comprises a bloom or foliage portion and a stem portion. Further, the floral grouping may comprise a growing potted plant having a root portion (not shown) as well. However, it will be appreciated that the floral grouping may consist of only a single bloom or only foliage, or a botanical item (not shown), or a propagule (not shown). The term “floral grouping” may be used interchangeably herein with both the terms “floral arrangement” and “potted plant”. The term “floral grouping” may also be used interchangeably herein with the terms “botanical item” and/or “propagule”.

The term “growing medium” when used herein means any liquid, solid or gaseous material used for plant growth or for the cultivation of propagules, including organic and inorganic materials such as soil, humus, perlite, vermiculite, sand, water, foam, and including the nutrients, fertilizers or hormones or combinations thereof required by the plants or propagules for growth.

The term “botanical item” when used herein means a natural or artificial herbaceous or woody plant, taken singly or in combination. The term “botanical item” also means any portion or portions of natural or artificial herbaceous or woody plants including stems, leaves, flowers, blossoms, buds, blooms, cones, or roots, taken singly or in combination, or in groupings of such portions such as bouquet of floral grouping.

The term “propagule” when used herein means any structure capable of being propagated or acting as an agent of reproduction including seeds, shoots, stems, runners, tubers, plants, leaves, roots, or spores.

In accordance with the present invention a bonding material may optionally be disposed on a portion of any of the floral sleeves 10-10h described herein to attach each floral sleeve 10-10h to a flower pot 62 having a floral grouping 82 therein when such a flower pot 62 is disposed within the floral sleeve 10-10h or to assist in closing or sealing the upper portion 74 or 74d-74h of the floral sleeve 10c-10h or in adhering the floral sleeve 10-10h to the flower pot 62 after the flower pot 62 has been disposed therein. Examples of how a bonding material may be disposed on the floral sleeve 10-10h are shown in U.S. Pat. No. 5,493,809 and in U.S. Pat. No. 5,625,979, each of which is hereby expressly incorporated herein by reference in its entirety.

The term “detaching element” 80 and 80d-80h when used generally herein, means any element or device such as, but not limited to, perforations, tear strips, zippers, and any other devices or elements of this nature known in the art, or any combination thereof, which enable the tearing away or detachment of one object from another. Therefore, while perforations are shown and described in detail herein, it will be understood that tear strips, zippers, or any other “detaching element” known in the art, or any combination thereof, could be substituted therefore and/or used therewith.

The upper portions 74 and 74d-74h of the floral sleeves 10c-10h, respectively may also have an additional vertical detaching element comprising a plurality of vertical perforations (not shown) for facilitating removal of the upper portion 74 or 74d-74h and which are disposed more or less vertically therein.

It will be understood by a person of ordinary skill in the art that equipment and devices for forming flexible floral sleeves are commercially available, and are well known to a person of ordinary skill in the art. Therefore, further detailed discussion of the construction of the sleeves described herein is not deemed necessary.

However, briefly, the flexible floral sleeves 10-10h described herein may be formed by intermittently advancing, one or two webs preformed in the form of a tube, or a single web folded double, indenting the lower end to form a folded pouch portion for forming the gusset, and sealing the longitudinal sides of the two facing panels, then cutting the floral sleeve 10-10h thus formed from the webs or web. Machines which can form floral sleeves 10-10h from such single webs or tubes are well within the knowledge of one of ordinary skill in the art.

The term “flower pot 62” as used herein refers to any type of container used for holding a floral grouping or plant, including vases. Examples of pots, used in accordance with the present invention include, but are not limited to, clay pots, foam pots, wooden pots, plastic pots, pots made from natural and/or synthetic fibers, and/or any combination thereof. The flower pot 62 is adapted to receive a floral grouping 82 in the retaining space thereof. The floral grouping 82 may be disposed within the flower pot 62 along with a suitable growing medium described elsewhere herein, or other retaining medium, such as a floral foam. It will also be understood that a floral grouping, botanical item or propagule and any appropriate growing medium or other retaining medium, may be disposed in the floral sleeve 10-10h without the flower pot 62 for displaying, transporting or cultivating the item disposed within the floral sleeve 10-10h.

Preferably the floral sleeve 10-10h is sized to contain and conform to one of a variety of standard sizes of pots known to those of ordinary skill in the art, such as 4 inch, 4½ inch, 5 inch, 5½ inch, 6 inch, 6½ inch, 7 inch, 7½ inch, 8 inch and 8½ inch pots or pots that are larger than, smaller than, or intermediate between such pot sizes.

Although not shown herein, any of the sleeves 10-10h described herein may be used as a container for a growing medium and a floral grouping 82 wherein the floral grouping 82 is disposed within the growing medium without using a pot 62. In a preferred version, at least a portion of the sleeve 10-10h is constructed of a material resistant or impermeable to leakage, while the detachable upper portion, if present, is preferably constructed of a thinner transparent material.

Any of the floral sleeves described or contemplated herein, such as floral sleeves 10-10h may be secured about the pot 62 by a banding element or by forming a crimped portion which is held in a crimped shape by an adhesive or cohesive bonding material. The term “banding element” when used herein may include elastic bands, plastic bands, ties, wires, labels, bands, ribbons, stribbons, strings, tapes, staples, barbs, collars, clips and/or combinations thereof. The banding element or crimped portion could be positioned either above or below the upper end 66 of the pot 62 when the pot 62 is disposed in the interior space 30 of the floral sleeve 10-10h.

It should be further noted that various features of the versions of the present invention such as closure bonding areas, support apertures, handles or handle apertures, additional perforations, drainage holes, ventilation holes, combinations of material may be used alone or in combination as elements of any of the embodiments described above herein.

Changes may be made in the construction and the operation of the various components, elements and assemblies described herein or in the steps or the sequence of steps of the methods described herein without departing from the spirit and scope of the invention as defined in the following claims.

What is claimed is:

1. A method of covering a pot or floral grouping, comprising:
providing a floral sleeve comprising a body having an upper end, a lower end, a first panel having a first upper edge and a first lower edge, a second panel having a second upper edge and a second lower edge, an interior space and a gusset extending inwardly from the lower end into the interior space, the body having a single left side edge sealed from the upper end to the lower end, a single right side edge sealed from the upper end to the lower end, the first panel and the second panel together forming a sidewall in the body, the body tapered from the upper end to the lower end, the gusset having an inner fold extending from the single left side edge to the single right side edge, the body initially having a flattened condition, and wherein when the body is opened from the flattened condition to an opened condition for containing a pot or floral grouping, the gusset is unfolded to form a bottom in the body, the bottom having a lower bottom surface, a left side bottom surface extending upwardly from the lower bottom surface to the single left side edge, and a right side bottom surface extending upwardly from the lower bottom surface to the single right side edge;
opening the floral sleeve to expose the interior space; and
disposing a pot or floral grouping within the interior space of the floral sleeve to form a covered pot or covered floral grouping wherein the lower bottom surface of the bottom of the floral sleeve is flat when the pot is disposed within the floral sleeve, and wherein the bottom of the floral sleeve is substantially concealed by a lower portion of the sidewall of the floral sleeve.

2. The method of claim 1 wherein in the step of providing a floral sleeve, at least one of the first upper edge and the second upper edge of the body has a substantially horizontal pattern.

3. The method of claim 1 wherein in the step of providing a floral sleeve, at least one of the first upper edge and the second upper edge of the body has an angular pattern.

4. The method of claim 1 wherein in the step of providing a floral sleeve, at least one of the first upper edge and the second upper edge of the body has a non-linear pattern.

5. The method of claim 1 wherein in the step of providing a floral sleeve, the floral sleeve further comprises an upper portion extending from the upper end of the body, wherein the upper portion is detachable from the upper end of the body via a detaching element.

6. The method of claim 5 wherein the upper portion comprises at least one upper support element adapted to support the body from a support device.

7. The method of claim 5 wherein the upper portion is sized to surround and encompass the floral grouping disposed within the pot or alone within the floral sleeve in the opened condition.

8. The method of claim 5 wherein the upper portion is adapted to support the body from a support device wherein the upper portion is sized to surround and encompass the floral grouping disposed within the pot or alone within the floral sleeve in the opened condition.

9. The method of claim 5 wherein the detaching element comprises a plurality of perforations.

10. The method of claim 1 wherein in the step of providing a floral sleeve, the floral sleeve is provided by detaching the floral sleeve from a pad of the floral sleeves.

11. The method of claim 1 comprising the additional step of securing the floral sleeve about the pot or floral grouping by disposing a securing element about the floral sleeve after the floral sleeve has been disposed about the pot or floral grouping.

12. The method of claim 11 wherein the securing element is selected from the group consisting of elastic bands, plastic bands, strings, ribbons, ties, wires, stribbons, rubber bands, tapes, barbs, collars, staples, labels, and clips and combinations thereof.

13. The method of claim 11 wherein the securing element is placed above an upper end of the pot.

14. The method of claim 11 wherein the securing element is placed below an upper end of the pot.

15. The method of claim 1 wherein the floral sleeve further comprises a skirt portion in an upper portion of the body.

16. A method of covering a pot or floral grouping, comprising:
providing a floral sleeve comprising a body having an upper end, a lower end, a first panel having a first upper edge and a first lower edge, a second panel having a second upper edge and a second lower edge, an interior space and a gusset extending inwardly from the lower end into the interior space, the body having a single left side edge sealed from the upper end to the lower end, a single right side edge sealed from the upper end to the lower end, the first panel and the second panel together forming a sidewall in the body, the body tapered from the upper end to the lower end, the gusset having an inner fold extending from the single left side edge to the single right side edge, the body initially having a flattened condition, and wherein when the body is opened from the flattened condition to an opened condition for containing a pot or floral grouping, the gusset is unfolded to form a bottom in the body, the bottom having a lower bottom surface, a left side bottom surface extending upwardly from the lower bottom surface to the single left side edge, and a right side bottom surface extending upwardly from the lower bottom surface to the single right side edge, and an upper portion extending from the upper end of the body, wherein the upper portion is detachable from the upper end of the body via a detaching element, and wherein the detaching element comprises a plurality of perforations having a non-linear pattern, such that when the upper portion is detached from the upper end of the body, the upper end of the body is left with an upper edge having a non-linear pattern;
opening the floral sleeve to expose the interior space; and
disposing a pot or floral grouping within the interior space to form a covered pot or covered floral grouping wherein the lower bottom surface of the bottom of the floral sleeve is flat when the pot is disposed within the floral sleeve, and wherein the bottom of the floral sleeve is substantially concealed by a lower portion of the sidewall of the floral sleeve.

17. The method of claim 16 wherein in the step of providing a floral sleeve, the floral sleeve is provided by detaching the floral sleeve from pad of floral sleeves.

18. The method of claim 16 comprising the additional step of securing the floral sleeve about the pot or floral grouping by disposing a securing element about the floral sleeve after the floral sleeve has been disposed about the pot or floral grouping.

19. The method of claim 18 wherein the securing element is selected from the group consisting of elastic bands, plastic bands, strings, ribbons, ties, wires, stribbons, rubber bands, tapes, barbs, collars, staples, labels, and clips and combinations thereof.

20. The method of claim 18 wherein the securing element is placed above an upper end of the pot.

21. The method of claim 18 wherein the securing element is placed below an upper end of the pot.

22. The method of claim 16 wherein the upper portion comprises an upper support element adapted for supporting the floral sleeve from a support device.

23. The method of claim 16 wherein the floral sleeve further comprises a skirt portion in an upper portion of the body.
